(19) United States
(12) Patent Application Publication
(10) Pub. No.: US 2004/0191128 A1
(43) Pub. Date: Sep. 30, 2004

(54) Slide stainer with heating

(75) Inventors: Steven A. Bogen, Sharon, MA (US); Herbert H. Loeffler, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: CytoLogix Corporation, Cambridge, MA

(21) Appl. No.: 10/823,368

(22) Filed: Apr. 12, 2004

Related U.S. Application Data
(63) Continuation-in-part of application No. 09/702,298, filed on Oct. 31, 2000.
Application No. 09/702,298 is a continuation of application No. 09/205,945, filed on Dec. 4, 1998, now Pat. No. 6,180,061.
Application No. 09/205,945 is a continuation-in-part of application No. 08/887,178, filed on Jul. 2, 1997, now Pat. No. 5,947,167.
Application No. 08/887,178 is a continuation-in-part of application No. 08/251,597, filed on May 31, 1994, now Pat. No. 5,645,114.
Application No. 08/251,597 is a continuation-in-part of application No. 07/881,397, filed on May 11, 1992, now Pat. No. 5,316,452.

(51) Int. Cl. B01L 3/00

(52) U.S. Cl. 422/100

(57) ABSTRACT

A microscope slide stainer includes a platform that supports a plurality of microscope slides. The platform includes surface areas, heated by resistive heaters, under the microscope slides. A liquid dispenser is located above the platform and the dispenser and platform are adapted for relative movement with respect to each other. The dispenser dispenses liquid reagents onto a slide bearing a biological sample.

### RELATED APPLICATIONS

This application is a Continuation-in-Part of U.S. application Ser. No. 09/702,298 filed Oct. 31, 2000, which is a Continuation of U.S. application Ser. No. 09/205,945 filed Dec. 4, 1998, now U.S. Pat. No. 6,180,061, which is a Continuation-in-Part of U.S. application Ser. No. 08/887,178, filed Jul. 2, 1997, now U.S. Pat. No. 5,947,167, which is a Continuation-in-Part of U.S. application Ser. No. 08/251,597, filed May 31, 1994, now U.S. Pat. No. 5,645,114, which is a Continuation-in-Part of U.S. application Ser. No. 07/881,397, filed on May 11, 1992, now U.S. Pat. No. 5,316,452, the entire teachings of which are incorporated herein by reference.

### GOVERNMENT SUPPORT

The invention was supported, in whole or in part, by a grant 1R43AI29778-02 from Department of Health and Human Services Public Health Service, Small Business Innovation Research Program. The Government has certain rights in the invention.

### BACKGROUND OF THE INVENTION

In a field of medical laboratory testing known as histopathology, a disease is diagnosed from a biopsy specimen by microscopic examination of the diseased tissue. Various molecules in a tissue section, mounted on a microscope slide, are colored. By causing the desired molecules to be colored, or “stained” as it is commonly called, their presence or quantity can be detected. The presence or quantity of specific molecules in a tissue biopsy can be important in rendering a diagnosis or determining therapy.

There are three different types of stains that are generally useful for staining tissue biopsies in this manner. Different stains are used for different purposes, to answer different clinical questions that may be important in determining the diagnosis. These stains are well known in the art. Histochemical stains are comprised of stains or dyes in the nature of chemicals. Examples of histochemical stains include the hematoxylin and eosin stain, periodic acid-Schiff stain, Gram stain, Grocott's methenamine silver stain, May-Grunwald Giemsa stain, acid fast stain, etc. In each of these stains, various chemicals cause the development of color in the tissue section, if the particular molecule(s) being tested for are present. Another type of stain is known as an immunohistochemical stain (IHC). IHC stains involve an immunologic reaction whereby an antibody detects a particular molecule. The presence of the antibody is then detected using a calorimetric reaction that is visible under microscopic examination. IHC stains are particularly useful for detecting specific types of proteins. A third type of stain is known as in situ hybridization (ISH). ISH stains detect specific nucleic acid sequences through complementary binding of a DNA or RNA probe. The presence of bound probe is then detected through a colorimetric reaction that is visible under microscopic examination. ISH stains are particularly useful for detecting specific genes, or nucleic acid sequences. All of these stains have various uses in the diagnosis of disease.

As these staining procedures have become increasingly important, instrumentation to automate the processes has been developed. The earliest types of stainers were batch stainers, in that all of the slides were treated in a similar fashion. Commonly performed stains are also called routine stains. The stains performed in batch stainers included the hematoxylin and eosin stain, a routine stain that is commonly performed on most biopsy specimens. Later, stainers were developed that provided flexibility in the staining protocols for the different slides. Namely, different slides in the instrument can be processed according to different staining protocols. This feature is generally referred to in the art as random access. Random access slide stainers are relatively recent developments, as the need for non-routine staining has increased. Non-routine stains are those stains that are typically performed on an as-needed basis, to answer specific clinical questions for the patient biopsy. Immunohistochemical and in situ hybridization stains are typically considered non-routine stains. In addition, many histochemical stains are also considered non-routine, in that they are performed on specific patient samples in order to address a diagnostic question of importance to that patient. In the art, these non-routine histochemical stains are also called “special stains”.

Many of the non-routine stains, including special stains, immunohistochemical or in situ hybridization stains, call for the application of heat at a certain point in time during the staining procedure. Therefore, when designing instrumentation for performing the stains automatically, it is desirable to provide for the application of heat to the slides.

### SUMMARY OF THE INVENTION

In a microscope slide stainer, a platform supports a plurality of microscope slides. The platform has at least one heated surface area heated by a heater thereunder. The heated surface area is in contact with and underlies at least one microscope slide bearing a biological sample. A liquid dispenser dispenses liquid reagents onto the slide bearing the biological sample. The liquid dispenser is located above the platform, and the dispenser and platform are adapted for relative movement with respect to each other.

The slide stainer may comprise a plurality of heated surface areas, and each heated surface area may support only one slide. A slide support on the platform may have plural heated surface areas, and there may be plural slide supports on the platform.

A resistive heating element may underlie the heated surface area. To provide the relative movement, either the liquid dispensing station, or the platform, or both may move. In one embodiment, the liquid dispensing station is stationary and the platform moves to index slides to the liquid dispensing station.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a cross-sectional view of the pump cartridge and dispensing actuator mounted on a frame.

FIG. 2 is a perspective view of the pump cartridge reservoir.

FIG. 3 is a view from above of the pump cartridge.

FIG. 4 is a view from above of a plurality of pump cartridges mounted on a first embodiment dispensing assembly including a rectangular frame and chassis of an X-Y axis robot.

FIG. 5 is a perspective view of a dispensing assembly of a second embodiment of the invention.

FIG. 6 is a top view of a slide frame for providing five sealed cavities above five different slides holding tissue samples.

FIG. 7 is a top view of a slide frame base.

FIG. 8 is a top view of a slide frame housing.

FIG. 9 is a side cross-sectional view showing the dispensing actuator of the dispensing station and an exemplary cartridge pump being engaged by the dispensing actuator.

FIG. 10 is a side cross-sectional view of a rinse device housed in the dispensing station.

FIGS. 11A and 11B are side cross-sectional views of a vacuum hose and transport mechanism for removing rinse and reagent from slides contained on the slide rotor.

FIGS. 12-14 are cross-sectional views of the uppermost portion of the cartridge reservoir, demonstrating alternative constructions.

FIGS. 15 and 16 are longitudinal sectional views of an alternative dispenser pump cartridge embodying the invention.

FIG. 17 is a longitudinal sectional view of the metering chamber tubing of the embodiment of FIGS. 15 and 16.

FIG. 18 is a cross-sectional view of a valve needle and plate used in the embodiment of FIGS. 15 and 16.

FIG. 19A and 19B are side cross-sectional views of the liquid aspiration station of the second embodiment, with the aspiration head in the lowered (FIG. 19A) and raised (FIG. 19B) positions.

FIG. 20 is a schematic representation of the individual heaters on the slide rotor and the temperature control boards mounted on the slide rotor.

FIG. 21A-D are a schematic diagram of the electronic circuitry of the temperature control board.

### DETAILED DESCRIPTION OF THE INVENTION

A description of preferred embodiments of the invention follows.

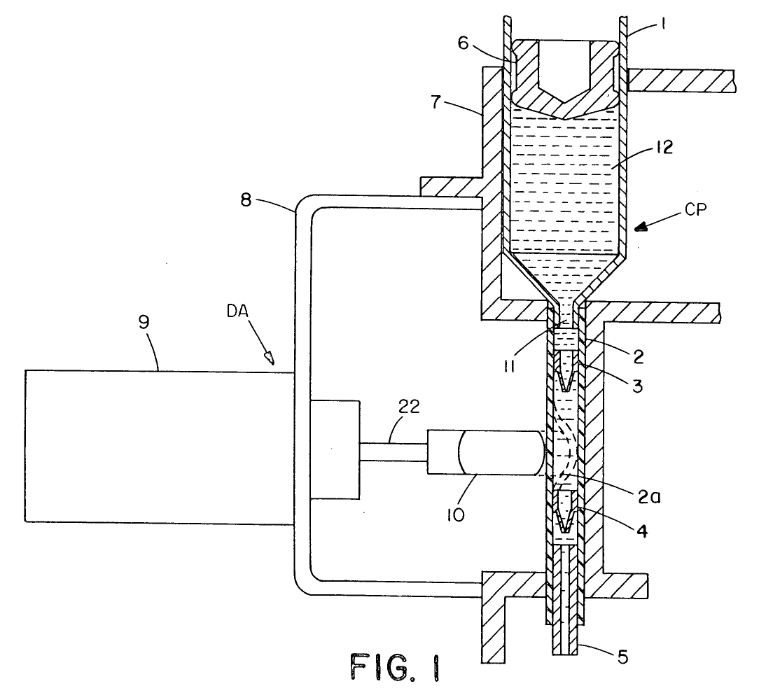

Referring to FIG. 1, the cartridge pump CP comprises a pump cartridge reservoir 1 in the shape of a cylindrical barrel. The cartridge reservoir 1 has a lower outlet 11 which is directly connected to a metering chamber comprised of a segment of compressible tubing 2, an inlet valve 3, and an outlet valve 4. The distance between the inlet valve 3 and the outlet valve 4, and the inner diameter of the tubing 2 defines a volume which can be filled with a liquid. A nozzle 5 is placed below the outlet valve 4 for the purpose of decreasing the flow velocity of the liquid. The cartridge reservoir contains a volume of liquid 12 which is sealed from above by a sliding plunger 6. The cartridge reservoir 1, inlet valve 3, outlet valve 4, plunger 6, metering chamber 2, and nozzle 5 are the components of the cartridge pump CP.

In a first embodiment of a dispensing assembly, the cartridge pump CP rests on a rectangular frame 7 which can be made of plastic. A single rectangular frame 7 can hold a plurality of cartridge pumps CP. The rectangular frame 7 can be removed from the chassis 8 by simply lifting the frame, thereby lifting all the cartridge pumps with it. In this manner, the wetted components can be easily separated from the electromechanical components.

The first embodiment dispensing assembly further includes dispensing actuators DA. Each dispensing actuator DA comprises a solenoid 9, arm 22, and rubber hammer 1. When an electrical current is applied to the solenoid 9, the arm 22 extends forcefully, thereby pressing the rubber hammer 10 against the outer wall of the metering chamber tubing 2. This action deforms the tubing, causing the compressible tubing to assume a compressed shape 2a. Since the total volume inside the metering chamber between the valves 3 and 4 is decreased, a volume of liquid is expelled in the direction defined by the valves 3 and 4. In FIG. 1, the valves are shown as allowing fluid in the downward direction only. Since the diameter of the outlet valve 4 leaflets is comparatively narrow relative to the diameter of the tubing 2, the fluid has a high flow velocity. This results in a forceful squirting of the liquid. This aspect is often undesirable, since it may lead to splattering of the liquid if the object surface of the fluid is situated immediately below. Therefore, the nozzle 5 is placed below the outlet valve 4. The nozzle has an inner diameter greater than the diameter of the outlet valve 4 leaflets. This aspect causes the high velocity fluid to first accumulate in the space above and within the inner aspect of the nozzle. The liquid thus exits the nozzle 5 at a slower velocity, ideally in a dropwise manner.

The rubber hammer 10 is also compressible in order to further decrease the flow velocity of the liquid. Most solenoids tend to extend suddenly and forcefully. This results in a very rapid compression of the tubing 2. In order to decrease this rate of compression, the solenoid arm is fitted with a compressible rubber hammer 10 which absorbs some of the initial force upon impact with the tubing 2.

The tubing 2 can be made of silicone rubber, vinyl, polyurethane, flexible polyvinyl chloride (PVC) or other synthetic or natural resilient elastomers. Such types of tubing are commonly used for peristaltic pumps. The valves can be obtained from Vernay Laboratories, Inc., Yellow Springs, Ohio, 45387 (part #VL 743-102).

When the electrical current is removed from the solenoid 9, the arm 22 and rubber hammer 10 is retracted from the surface of the tubing 2. The tubing in the compressed position 2a thereby reverts back to its native position 2 because of the resiliency of the tubing. The reversion of the tubing to its native position results in a negative pressure being created within the metering chamber, causing liquid 12 to be drawn from the pump reservoir 1 into the metering chamber. The metering chamber is therefore automatically primed for the next pump cycle.

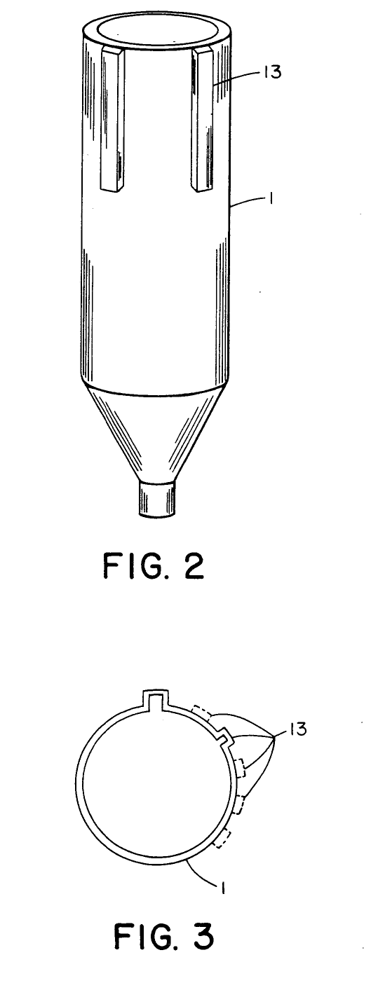

Referring to FIG. 2, the outer aspect of the pump cartridge reservoir 1 has longitudinal ridges 13. These ridges fit into grooves in the frame 7, see FIG. 1, in a lock and key fashion. Different cartridges are manufactured with different patterns of ridges in order to identify the contents. In this manner, any particular cartridge will fit only into a position of the frame with a corresponding pattern of grooves. This feature will prevent the possibility of the operator placing the cartridge in an unintended position of the frame.

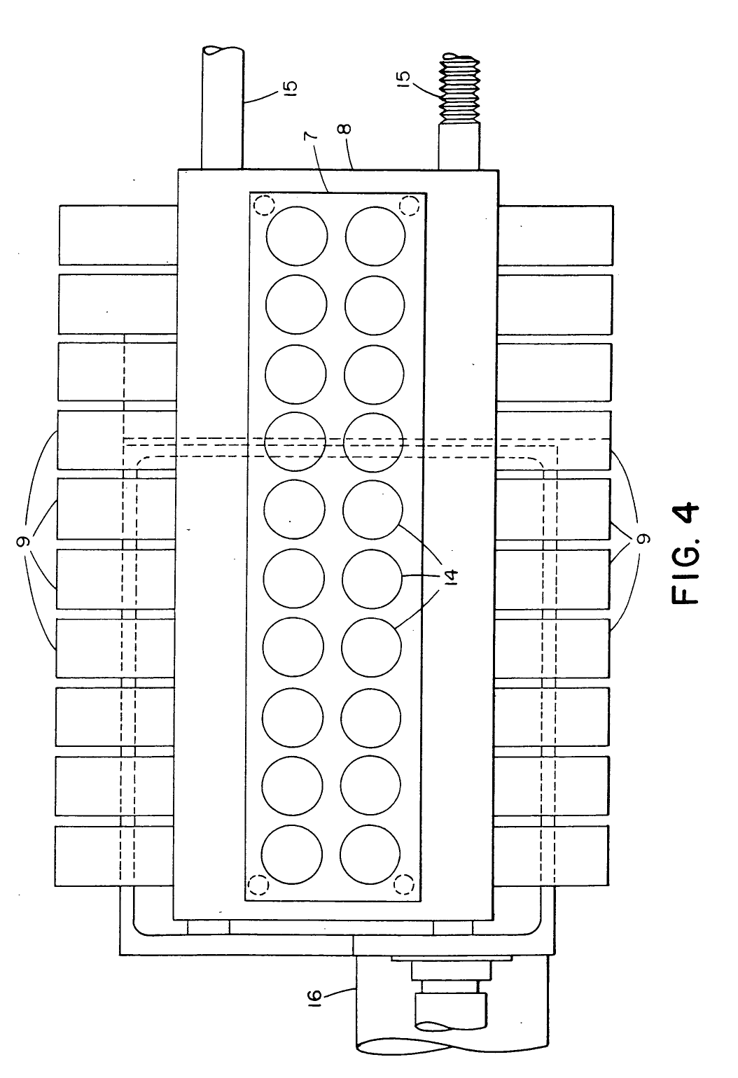

Referring to FIG. 3, this shows the variety of possible positions for ridges 13 on the outer surface of the pump cartridge reservoir 1.

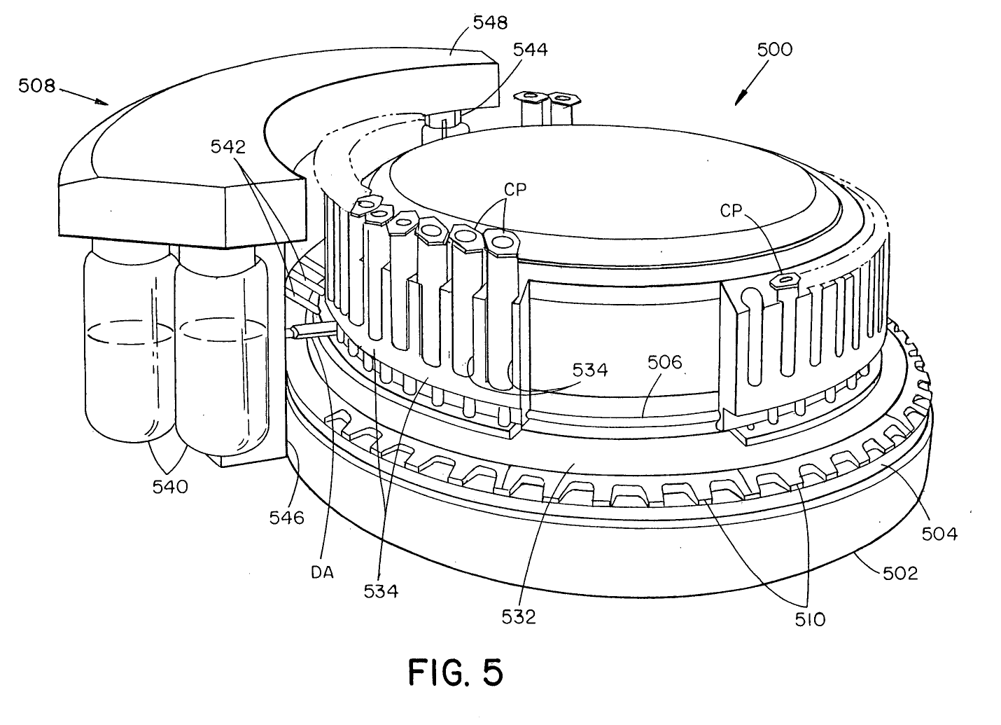

Referring to FIG. 4, this shows the first embodiment of the dispensing assembly comprising a rectangular frame 7 having plurality of slots 14 for cartridge pumps in position on the chassis 8 a different dispensing actuator DA being associated with each cartridge pump CP. The chassis is mounted on a pair of cylindrical bars 15. In this case one of the bars is threaded and attached to a motor 16. Alternatively, a cable drive may be provided. The motor can be a conventional stepping motor or servo motor and driven by a computer-generated signal through an electronic interface.

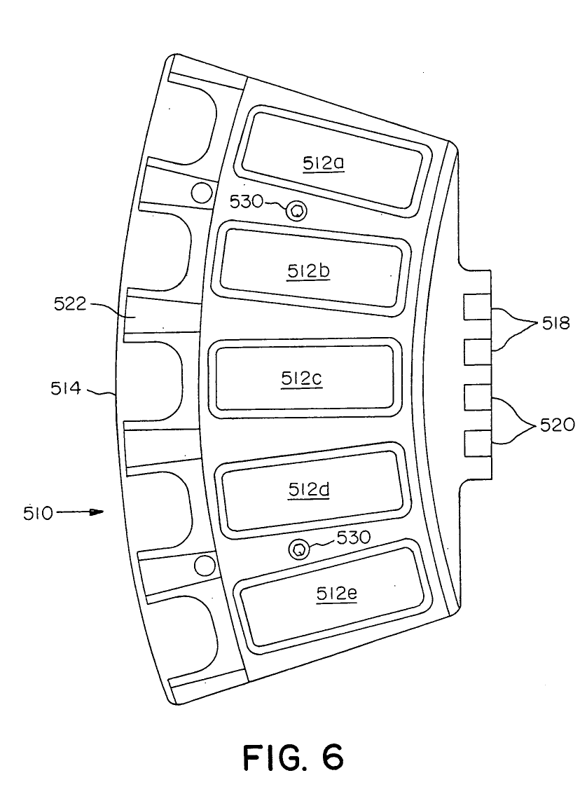

FIG. 5 shows a second embodiment 500 of a dispensing assembly in perspective. Generally, the dispensing assembly 500 comprises a substantially circular assembly base 502, a slide rotor 504 rotatable on the assembly base 502, a reagent rotor 506 also rotatable on the assembly base, and a dispensing station 508.

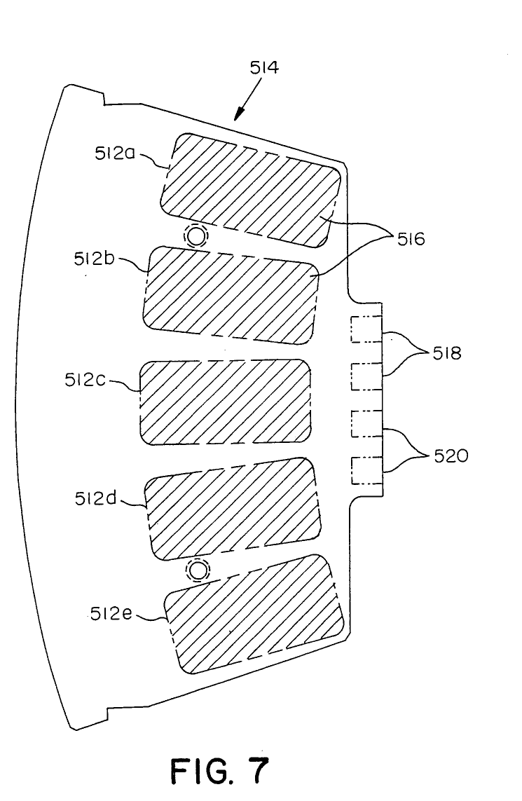

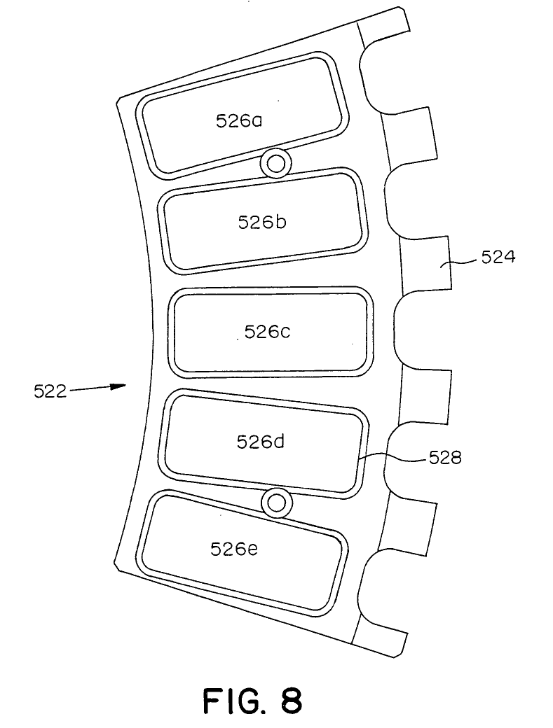

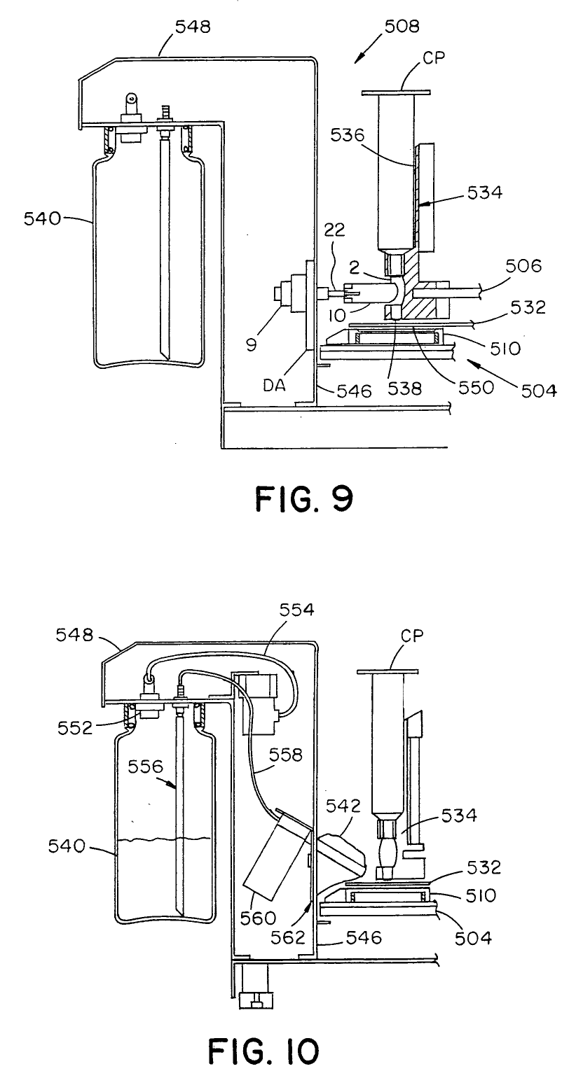

The slide rotor 504 is driven to rotate by a servo motor (not shown) and carries ten slide frames 510 that are radially asserted into and detachable from it. A top view of single slide frame 510 is shown in FIG. 6. Here, a different slide holding a tissue sample is held in each slide position 512a-512e. The slide frame 510 comprises a slide frame base 514 shown in FIG. 7. The slide frame base includes a plurality of heated areas 516 which underlie each of the slide positions 512a-512e and incorporate resistive heating elements, not shown. The heating elements are integrally formed in the slide frame base 514. Electricity for powering the elements is provided into the slide frame 510 from the assembly base 502 via first and second contacts. Further, third and fourth contacts 520 enable temperature sensing of the heated areas via thermocouples also integrally formed in the slide frame base 514. Adapted to overlay the slide frame base is a slide frame housing 522. FIG. 8 is a top view of the slide frame housing 522 showing essentially a rigid plastic or metal frame 524 with five oval holes 526a-526e corresponding to each of the slide positions 512a-512e. A silicon rubber gasket 528 is also provided under the plastic frame 524. Returning to FIG. 6, the slide frame housing 522, including the gasket 528 and plastic frame 524, is bolted onto the slide frame base 514 by two Allen bolts 530 to provide individual sealed cavities approximately 0.2-0.4 inches deep over each tissue sample slide placed at each of the slide positions 512a-512e. As a result, a total of 3 ml of reagents and/or rinses can be placed in contact with the tissue samples of each one of the slides but a maximum quantity of 2 ml is preferable. Since the silicone gasket 528 is compressed by the plastic frame 522 against the slide frame base 514, the cavities over each of the frame positions are mutually sealed from each other.

Returning to FIG. 5, above the slide rotor 504 is a non-rotating slide cover 532. This disk-like structure rides above the slide rotor 504 but does not turn with the slide rotor. Basically, it forms a cover for all of the tissue samples held in each of the slide frames 510 so that evaporation of reagents or rinses contained on the slides can be inhibited and also so that environmental contamination of the tissue samples is prevented.

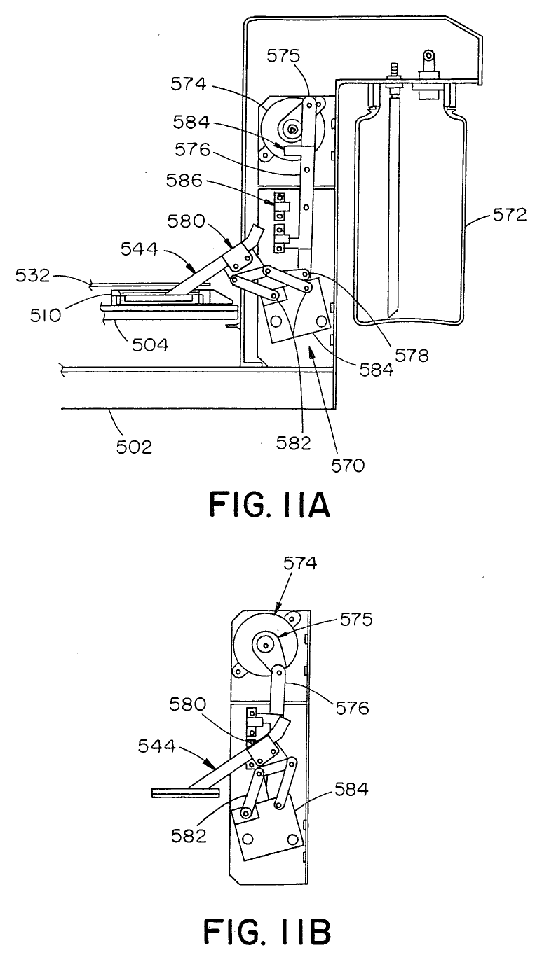

Positioned above the slide rotor 504 is the reagent rotor 506. This reagent rotor 506 is similarly adapted to rotate on the assembly base 502 and is driven by another servo motor (not shown) so that the reagent rotor 506 and slide rotor 504 can rotate independently from each other. The reagent rotor 506 is adapted to carry up to ten arcuate cartridge frames 534. These arcuate cartridge frames are detachable from the reagent rotor 506 and can be selectively attached at any one of the ten possible points of connection. Each arcuate cartridge frame 534 is capable of carrying five of the reagent cartridge pumps CP. A cross sectional view illustrating the arcuate cartridge frame as shown in FIG. 9. As illustrated, the reagent cartridge pump CP is vertically insertable down into a slot 536 in the arcuate cartridge frame 534 so that the nozzle tip 538 extends down below the cartridge frame and the meter chamber tubing 2 is exposed. The arcuate cartridge frame 534 including any cartridge pumps CP is then slidably insertable onto the reagent rotor 506.

Generally, the dispensing station 508 comprises a dispensing actuator DA for engaging the meter chamber tubing 2 of any one of the reagent cartridge pumps CP in any slot in any one of the arcuate cartridge frames 534. Further, the dispensing station 508 includes rinse bottles 540 that can supply rinses into any one of the slides on any one of the slide frames 510 via rinse tubes 542, and a rinse removal vacuum 544 including a vacuum tube that is extendable down into any one of the cavities in the slide frames 510 to remove rinse or reagent.

Specifically, the dispensing station 508 includes a station frame that has a front wall 546 generally following the curvature of the assembly base 502. The station frame also includes a horizontal top wall 548 continuous with the front wall 546 and from which rinse bottles 540 are hung. The front wall 546 of the station housing supports a single dispensing actuator DA. As best shown in connection with FIG. 9, the dispensing actuator DA includes a solenoid or linear stepping motor 9, an arm 22, and a compressible rubber hammer 10 as described in connection with the dispensing actuator illustrated in FIG. 1. Use of a linear stepping motor instead of a solenoid somewhat negates the necessity of the rubber hammer being highly compressible since the rate of extension of linear stepping motors can be controlled to a slow speed. Because only a single dispensing actuator is required in the second embodiment, more expensive alternatives such as the linear stepping motor are preferable. As another possible alternative, the reciprocating hammer of the dispensing actuator could take the form of a cam, driven by a rotary motor, that engages the compressible tubing so that rotation of the cam will deform the compressible tubing.

Upon actuation of the solenoid 9, the rubber hammer 10 extends outwardly to engage the compressible tubing 2 of the particular cartridge pump CP that has been rotated into position in front of the dispensing actuator DA on the reagent rotor 504. The liquid dispensed from the pump cartridge CP by the action of the dispensing actuator DA falls down through a hole 550 formed in the slide cover 532 into the particular medical slide that has been brought into position in front of the dispensing actuator DA by the rotation of the slide rotor 504. In this way, any one of fifty slides, which the slide rotor 504 is capable of carrying, can be accessed and treated with any one of fifty different reagents that the reagent rotor 506 is capable of carrying in the cartridge pumps CP by properly rotating both the reagent rotor and the slide rotor. By this method both the reagent cartridge pump CP carrying the desired reagent and the slide which the operator intends to receive this reagent are brought to circumferential position of the dispensing actuator DA.

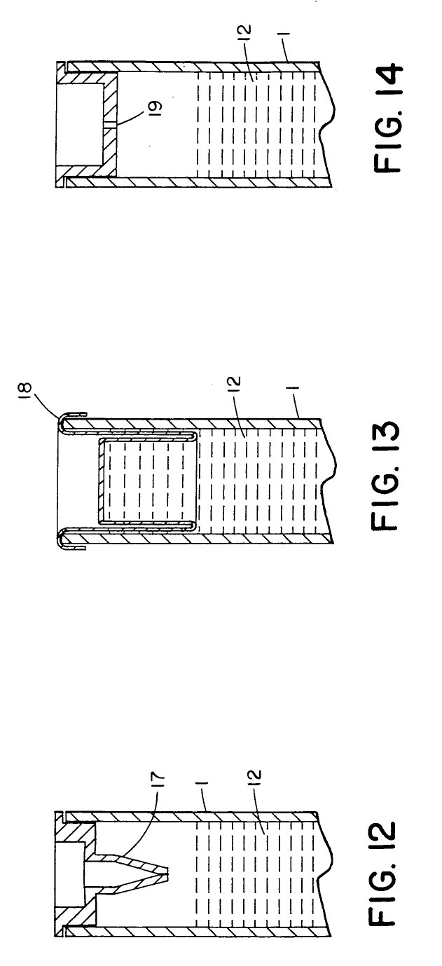

The dispensing station 508 also carries up to eight different rinses that can be delivered through rinse tubes 542 to any one of the slides held on the slide rotor 504. As shown in FIG. 10, the rinse bottles 540 are screwed into a female threaded cap 552 secured to the underside of the horizontal top wall 546 of the station frame. Compressed air is from a compressor 554 is provided into each one of the rinse bottles 540. The pressure above the rinse then enables the rinse to be forced out through the dip tube 556 through rinse hose 558 when a pinch valve 560 is opened. Depending on the length of time that the pinch valve is opened, a predetermined amount of rinse can be provided out through the rinse tube 542 into the particular medical slide that has been brought underneath the rinse tube end 562 by the rotation of the slide rotor. Eight different rinse tubes 542 corresponding to each rinse bottle 540 and each controlled by a separate pinch valve. Eight holes are provided in the slide cover 532 underneath the ends of the rinse tubes 542 so that the rinse can reach the slides.

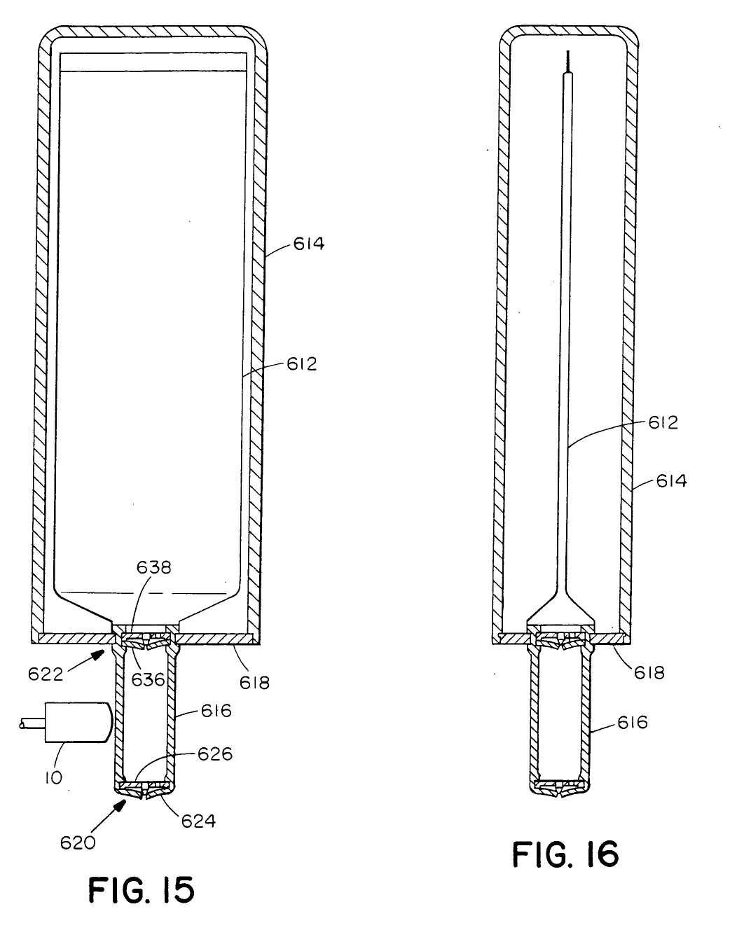

Returning to FIG. 5, also provided on the vertical wall 544 of the station housing is an extendable vacuum hose 544. As more completely shown in cross section in FIG. 11A, the vacuum hose 544 is supported by a hose transport mechanism 570 that allows the vacuum hose 544 to be extended down into a cavity of a slide frame 510 to remove any rinse and reagent covering the tissue sample of the slide. Specifically, the suction is created by a partial vacuum generated in vacuum bottle 572 by a compressor, not shown. Consequently, the rinse and reagent is sucked in through the vacuum hose 544 and into the vacuum bottle when the vacuum hose transport mechanism 570 brings the vacuum hose end in contact with the rinse and/or reagent in cavity of the slide frame 510.

The vacuum hose transport mechanism comprises a motor 574. A reciprocating link 576 is attached to a crank arm 575 so that the rotation of the motor 574 causes the reciprocating link 576 to traverse in a vertical direction. A bottom portion of the reciprocating link 576 is connected to a lever 578 that is pivotally attached to the station frame. The other end of this lever is connected to a vacuum hose clamp 580 that is connected via to pivot arms 582 to a plate 584 rigidly attached to the station frame. The net effect of these connections is that when the motor 574 is rotated, the slide arm 576 descends in the vertical direction. Thus, the lever 578 is pivoted clockwise around its fulcrum causing the hose clamp 580 to pivot up and away on the two pivot arms 582 from the slide as shown in FIG. 11b. The motor is automatically turned off as the slide reaches its two extreme ends of movement by the contact of the electrical terminals 584 of the slide to the contact plates 586 connected to the station frame.

A microprocessor, not shown, controls the entire dispensing assembly 500. That is, an operator programs the microprocessor with the information such as the location of reagents on the reagent rotor and the location of slides on the slide rotor. The operator then programs the particular histochemical protocol to be performed on the tissue samples. Variables in these protocols can include the particular reagent used on the tissue sample, the time that the tissue sample is allowed to react with the reagent, whether the tissue sample is then heated to exposed or develop the tissue sample, the rinse that is then used to deactivate the reagent, followed by the subsequent removal of the rinse and reagent to allow subsequent exposure to a possibly different reagent. The dispensing assembly enables complete random access, i.e. any reagent to any slide in any sequence.

An important aspect of the above-described invention is its ability to retain the fluid until such time as the solenoid hammer 10 presses on the metering chamber tubing 2. As will be noted from FIG. 1, both one-way valves 3 and 4 are aligned in the same direction, allowing only downward flow. It was found during construction that using valves with a low opening (“cracking”) pressure resulted in the liquid dripping out of the nozzle. There are two solutions to this problem. The most obvious is to use valves with an opening pressure greater than the pressure head of liquid. In this manner, the outlet valve 4 will not allow fluid exit until a certain minimum force is applied which is greater than the pressure head of the standing liquid.

A second alternative to prevent spontaneous dripping of the liquid out of the outlet valve 4 is to use a plunger 6 with an amount of friction against the inner surface of the reservoir 1 greater than the gravity pressure of the liquid 12. An additional advantage of the plunger 6 is that it prevents spillage of the liquid 12 from the top of the reservoir 1 (which would likely occur if the reservoir were left open from above). In this manner, the plunger will not be drawn downwards inside the reservoir merely by the weight of the liquid. However, when the metering chamber is emptied and a small amount of liquid is drawn from the reservoir 1 to refill the metering chamber, the plunger's friction to the reservoir wall is overcome. The plunger 6 thereby moves downward a distance proportional to the volume of liquid expelled. We have found it useful to apply a thin coat of a lubricant such as petroleum jelly to ensure that the plunger 6 moves smoothly downward within the reservoir.

Any combination of valve opening pressure and plunger friction may be used to prevent dripping, but given the low opening pressure typically found in valves of the type used, friction greater than gravity pressure of the liquid is preferred.

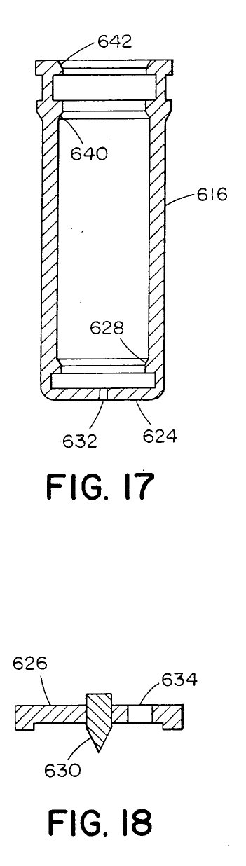

FIG. 12 shows another alternative construction of the cartridge top. Instead of using a plunger, a one-way valve 17 is placed at the top of the reservoir 1. The valve 17 has an opening pressure greater than the gravity pressure of the liquid within the reservoir. This third valve 17 is aligned in the same direction as the metering chamber valves 3 and 4. This allows the entrance of air into the reservoir as liquid is removed. In this case, cracking pressure of any or all of the three valves 3, 4 and 17 prevents spontaneous dripping from the outlet valve. Additionally, the valve 17 prevents spillage of the contents of the reservoir.

FIG. 13 shows another alternative construction for the top of the cartridge. A rolling diaphragm cover 18 is mounted at the top of the reservoir 1 and is drawn into the reservoir as the liquid is used up. This construction prevents spillage of the liquid 12 as well as provides a seal to prevent air entry. The rolling diaphragm can be made of any thin flexible elastomer such as natural rubber. The top of the rolling diaphragm can be sealed to the reservoir wall 1 by stretching the diaphragm over the reservoir, with an adhesive or by heat sealing.

FIG. 14 demonstrates a third alternative construction. The top of the reservoir is closed, except for a small aperture 19 for the entrance of air. The diameter of the aperture at the top of the reservoir can be sufficiently small to effectively prevent accidental spillage of the liquid contents of the cartridge but still allow air entry as liquid is dispensed from the cartridge.

A fluid level sensor may be provided adjacent to the cartridge reservoir. For example, a shaft can be connected to the top of the plunger. The shaft can be designed with a shape such that as it is drawn into the cartridge reservoir, it can optically or electrically open or close a circuit at a certain depth within the cartridge reservoir. In this manner, the shaft connected to the plunger can signal to a computer the depth of entry into the cartridge reservoir. The depth of entry would therefore be directly proportional to the amount of liquid remaining in the cartridge reservoir. Such an arrangement provides an automatic means for sensing the amount of liquid remaining inside the reservoir.

A variety of different configurations for the dispensing actuators DA may be used to apply pressure on the metering chamber tubing. Although a push-type of actuator DA is shown in FIG. 1, a rotary or pull-type could also be used with slight modifications to the design, as would be obvious so as to apply a pressure on the metering chamber tubing. Additionally, a solenoid valve could also be used to control pressure to a pneumatic cylinder whose piston rod is the actuator. Alternatively, a piezoelectric transducer may apply the pressure to the metering chamber tubing.

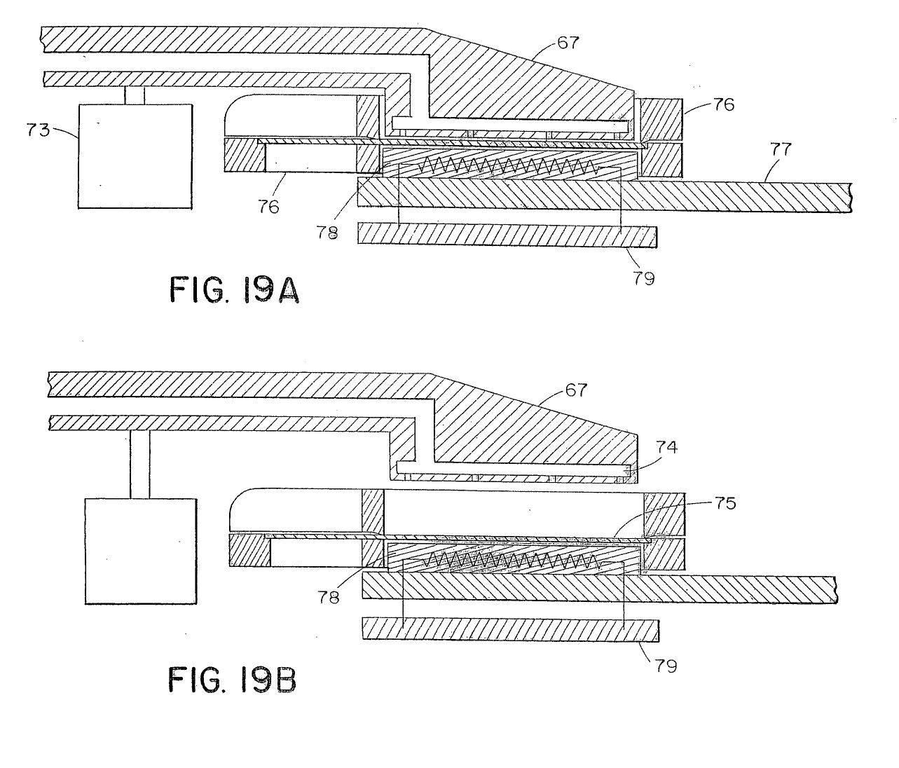

An alternative dispensing pump cartridge is illustrated in FIGS. 15 through 18. As in prior embodiments, the pump cartridge includes a liquid reservoir, in this case a flexible plastic bag 612 within a rigid housing 614. FIGS. 15 and 16 show the housing and longitudinal section in views from the front and side. FIG. 16 shows the bag collapsed, it being recognized that it would expand to fill the volume within the housing when filled with liquid. The open end of the reservoir bag 612 fits snugly about an inlet end of a metering chamber tube 616 and is clamped and thus sealed to the tube by a plate 618 which also serves as a closure to the housing 614. As in prior embodiments, the tube 616 is adapted to be compressed by an actuator 10 to expel liquid through a one-way outlet valve 620. When the actuator 10 is then released, the wall of the tube 616 returns to its native position and thus creates negative pressure within the metering chamber. That negative pressure draws liquid from the liquid reservoir 612 through a one-way inlet valve 622 into the metering chamber. Significantly, both valves are passive check valves, the dispensing being controlled by the single actuator 10. Mechanical complexity is avoided, and a cartridge may be readily replaced by dropping the cartridge into place with the tubing of the metering chamber positioned adjacent to the actuator 10.

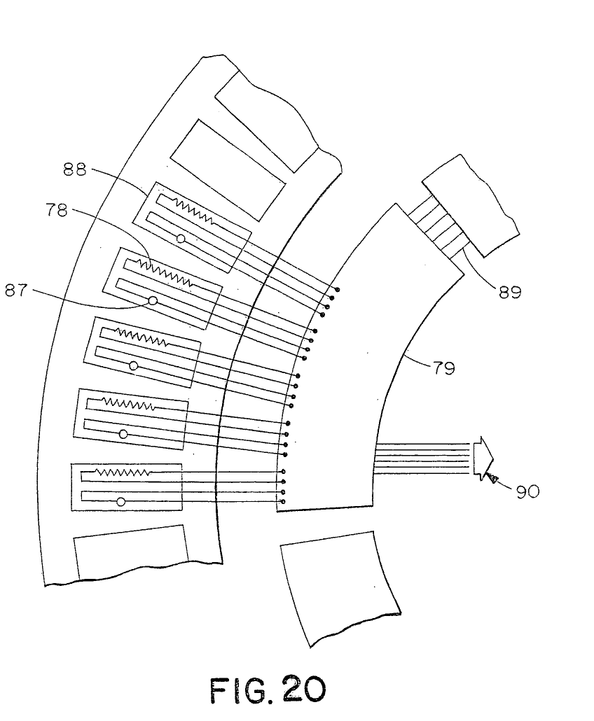

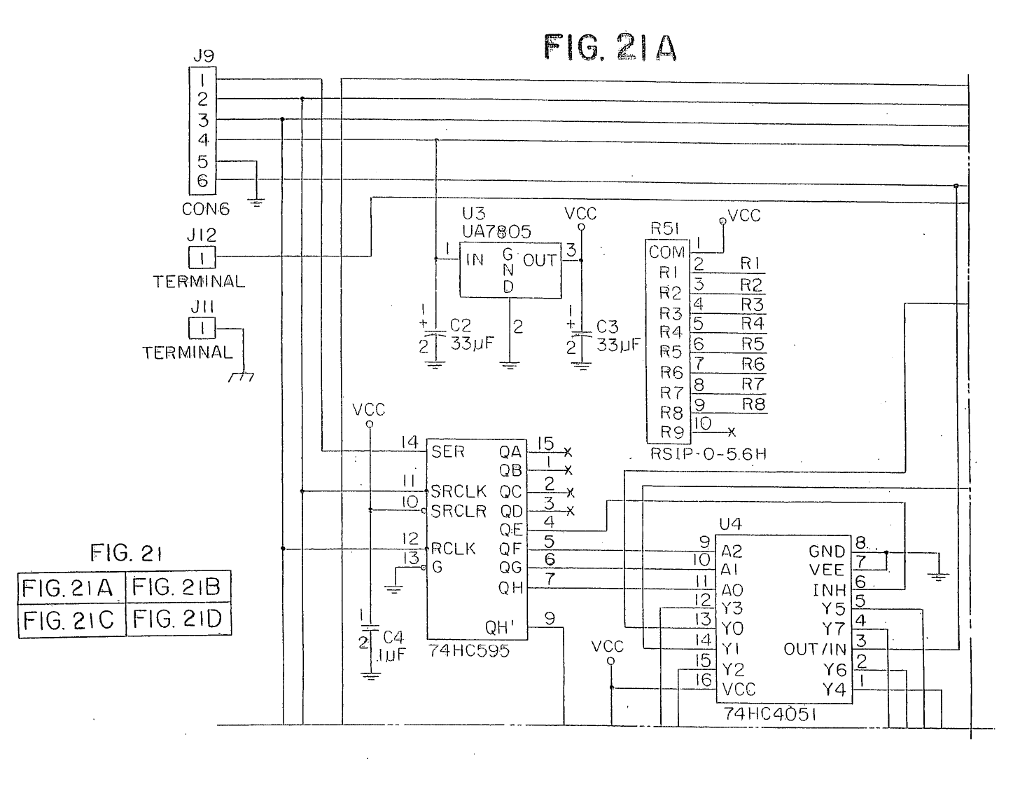

The novel valves of this embodiment provide relatively large sealing forces to minimize leakage while still requiring very small pressure differential to open. Further, the flow path below the sealing surface of the outlet valve 620 is minimal, thus minimizing any caking of reagent on flow surfaces. As in the embodiment of FIG. 1, the one-way valves are formed from flexible leaflets. However, in this embodiment a leaflet takes the form of a flat membrane having a central pinhole which seals against a pointed protrusion. Specifically, in the outlet valve 68, a membrane 624 is preferably formed of unitary plastic with the tube 616. A disk 626 (FIG. 18) snaps between the membrane 624 and a molded flange 628 within the metering chamber tube 616 (FIG. 17). A valve needle 630 extends as a protrusion from the plate 626. The needle may be a separate piece press fit into the plate 626 as illustrated in FIG. 18, or it may be molded as a unitary piece with the plate 626. The tip of the valve needle 630 extends into the pinhole 632 within the membrane 624, thus flexing the membrane in an outward direction. Due to the resiliency of the membrane, it presses back against the valve needle 630 with a sealing force sufficient to withstand the pressure head of the liquid contained within the metering chamber tube 616.

The plate 626 has a hole 634 to allow fluid flow therethrough. When the tube 616 is compressed by the actuator 10, the increased pressure within the metering chamber is applied across the entire upper surface area of the membrane 624 such that a low level of pressure is required to cause the membrane to flex and break the seal about the valve needle 630. Liquid then flows through the hole 634 and the pinhole 632.

The inlet valve 622 is similarly constructed with a membrane 636 and valve needle plate 638 retained within the internal flanges 640 and 642 in the metering chamber tube 616. With the low pressure differential required to open the valve, the tube 616 is able to return to its native position and draw liquid into the metering chamber from the reservoir 612. On the other hand, when the actuator 10 compresses the metering chamber 616, the force against the membrane 636 is sufficient to seal that membrane against the valve needle of the plate 638.

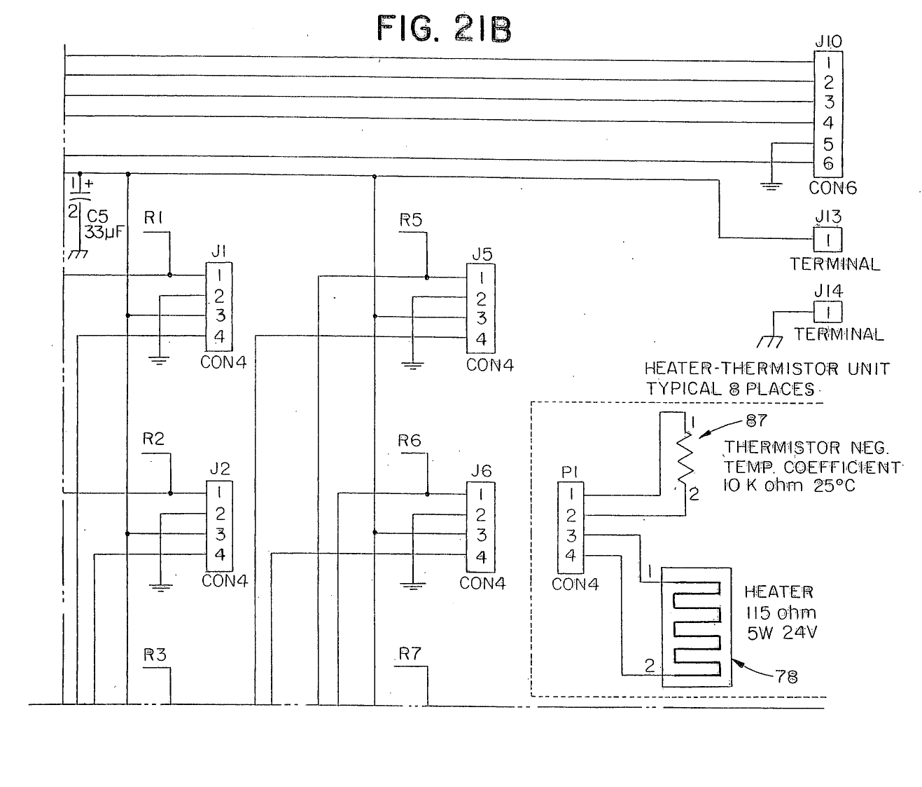

A more recent embodiment of the invention was presented in U.S. patent application Ser. No. 09/032,676, entitled, “Random Access Slide Stainer With Independent Slide Heating Regulation,” filed Feb. 27, 1998, now U.S. Pat. No. 6,183,693, which is incorporated by reference in its entirety. FIGS. 19-21 present an embodiment from that patent in which independent temperature control is provided to heated surfaces, each of which supports one slide.

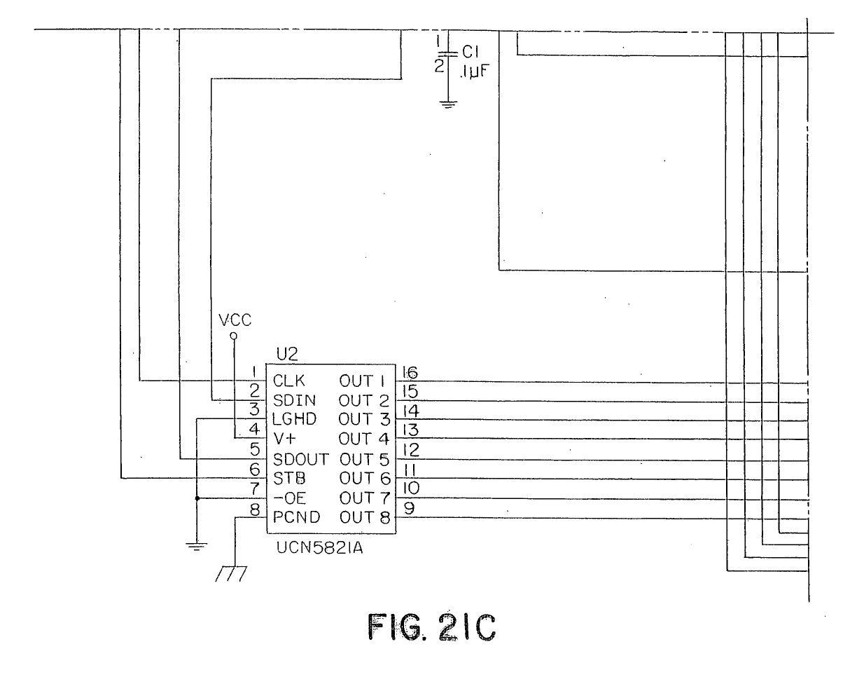

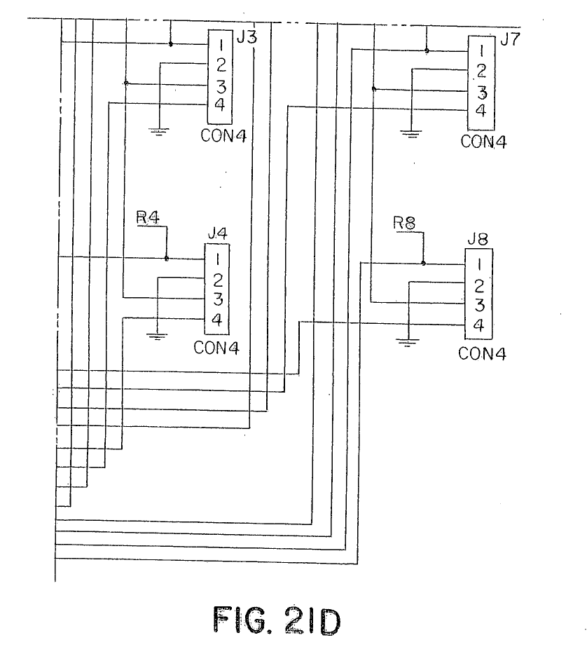

FIGS. 19A and 19B also show the physical location of a heating element 78, represented as a resistive element inside a rectangular box with cross-hatched lines. Each slide rests directly on the heating element 78, so that heat is directly communicated to the microscope slide. A thermistor is incorporated into each heating element (not shown in FIGS. 19A and 19B). Each of forty-nine microscope slides 75 has its own heating element 78, so that the temperature of each slide 75 can be independently regulated. Power for the heating element 78 is supplied directly from a temperature control board 79 that is affixed to the underside of the slide rotor 77. Seven identical temperature control boards 79 are so mounted underneath the slide rotor 77, evenly spaced around the periphery. Each temperature control board supplies power for seven heating elements 78. The means by which this is accomplished is explained in reference to FIGS. 20 and 21.

FIG. 20 shows the relationship between each of the heating elements 78 mounted on the slide rotor 77, depicting the heating element 78 as a resistive element. A single sensor 87 is adjacent to each heater. The combination of a single heating element 78 and sensor 87 are so positioned so as to provide a location 88 for a single slide to be heated. The physical layout of this location 88 is demonstrated in FIGS. 19A and 19B. Two wire leads from each heating element 78, and two wire leads from each sensor 87 are connected directly to a temperature control board mounted on the slide rotor 77. Each temperature control board is capable of connecting to up to eight different heater and sensor pairs. Since this embodiment incorporates forty-nine slide positions, seven boards 79 are mounted to the underside of the slide rotor, each connecting to seven heater-sensor pairs. One heater-sensor position per temperature controller board 79 is not used. Also shown in FIG. 20 is the serial connection 89 of each of the seven temperature control boards, in a daisy-chain configuration, by six wires. The first temperature control board is connected via a service loop 90 to the computer 86. The service loop contains only six wires tied together in a harness.

FIG. 21 is an electronic schematic diagram of the temperature control board 79. The design of the temperature control board 79 was driven by the need to minimize the number of wires in the flexible cable (service loop 90) between the heaters and the computer. To minimize the length of wires, seven temperature controller boards 79 are used, each mounted on the slide rotor. Thus, each heater is positioned close to its associated electronics and the size of each board 79 is kept small because each runs only seven heating elements 78. Each temperature controller board 79 includes the function of an encoder and decoder of temperature data. That data relates to the actual and desired temperature of each of heating elements 78. The data flows back and forth between the computer 86 and the temperature control board 79. If an individual heating element 79 requires more or less heat, the computer communicates that information to the temperature control board 79. The temperature control board 79, in turn, directly regulates the amount of power flowing to each heater. By placing some of the logic circuitry on the slide rotor, in the form of the temperature control boards 79, the number of wires in the service loop 90 , and their length, are minimized.

In this embodiment, the temperature control board 79 system was designed as a shift register. The machine's controlling microprocessor places bits of data one at a time on a transmission line, and toggles a clock line for each bit. This causes data to be sent through two shift register chips on each control board, each taking eight bits. There are thus 16×7 or 112 bits to be sent out. Referring to FIG. 21, the data comes in on connector J9.1, and the clock line is J9.2. The shift registers used in this design are “double buffered,” which means that the output data will not change until there is a transition on a second clock (R clock), which comes in on pin J9.3. The two clocks are sent to all seven boards in parallel, while the data passes through the shift register chips (U1 and U2) on each board and is sent on from the second shift register's “serial out” pin SDOUT to the input pin of the next board in daisy chain fashion. It will be seen that a matching connector, J10, is wired in parallel with J9 with the exception of pin 1. J10 is the “output” connector, which attaches via a short cable to J9 of the next board in line, for a total of seven boards. The other three pins of J9 are used for power to run the electronics (J9.4), electronic ground (J9.5), and a common return line (J9.6) for temperature measurement function from the sensors.

Of the sixteen data bits sent to each board, eight control the on/off status of up to eight heating elements 78 directly. This can be accomplished with a single chip because shift register U2 has internal power transistors driving its output pins, each capable of controlling high power loads directly. Four of the remaining eight bits are unused. The other four bits are used to select one thermistor 87 out of the machine's total complement of forty-nine. For reasons of economy and to reduce the amount of wiring, the instrument has only one analog-to-digital converter for reading the forty-nine temperature transducers (thermistors 87), and only one wire carrying data to that converter. This channel must therefore be shared between all of the transducers (thermistors 87), with the output of one of them being selected at a time. Component U4 is an analog multiplexer which performs this function. Of the four digital bits which are received serially, one is used to enable U4, and the other three are used to select one of the component's eight channels (of which only seven are used). If pin four is driven low, U4 for that board 79 becomes active and places the voltage from one of the seven channels of that board on the shared output line at J9.6. Conversely, if pin four is pulled high, U4's output remains in a high impedance state and the output line is not driven. This allows data from a selected board 79 to be read, with the remaining boards 79 having no effect on the signal. Multiplexer U4 can only be enabled on one board 79 at a time; if more than one were turned on at a time, the signals would conflict and no useful data would be transmitted.

Temperature sensing is accomplished by a voltage divider technique. A thermistor 87 and a fixed resistor (5.6 kilohms, R1-R8, contained in RS1) are placed in series across the 5 volt electronic power supply. When the thermistor is heated, its resistance drops and the voltage at the junction point with the 5.6 kilohm resistor will drop.

There are several advantages to the design used in this embodiment. Namely, the temperature control boards 79 are small and inexpensive. Moreover, the heater boards are all identical. No “address” needs to be set for each board 79. Lastly, the service loop 90 is small in size.

An alternative potential design is that each temperature control board 79 could be set up with a permanent “address” formed by adding jumper wires or traces cut on the board. The processor would send out a packet of data which would contain an address segment and a data segment, and the data would be loaded to the board whose address matched the address sent out. This approach takes less time to send data to a particular board, but the address comparison takes extra hardware. It also demands extra service loop wires to carry the data (if sent in parallel) or an extra shift register chip if the address is sent serially. As yet another potential design is that each temperature control board 79 could have its own microprocessor. They could all be connected via a serial data link to the main computer 86. This approach uses even fewer connecting wires than the present embodiment, but the cost of hardware is high. It also still implies an addressing scheme, meaning that the boards would not be identical. Also, code for the microprocessors would be required.

While this invention has been particularly shown and described with references to preferred embodiments thereof, it will be understood by those skilled in the art that various changes in form and details may be made therein without departing from the spirit and scope of the invention as defined by the appended claims. For example, the pump is operable with the metering chamber positioned above the reservoir. Disclosure Document No. 252981 filed May 10, 1990 at the U.S. Patent and Trademark Office shows details of a potential system embodying the present invention.

What is claimed is:

1. A microscope slide stainer, comprising:
a. a platform supporting a plurality of microscope slides, the platform having a heated surface area, heated by a heater thereunder, the heated surface area being in contact with and underlying a microscope slide bearing a biological sample; and
b. a liquid dispenser that dispenses liquid reagents onto the slide bearing the biological sample, said liquid dispenser being located above said platform, said liquid dispenser and platform being adapted for relative movement with respect to each other.

2. A microscope slide stainer as claimed in claim 1, further comprising a plurality of heated surface areas.

3. A microscope slide stainer as claimed in claim 1, wherein the heated surface area supports only one slide.

4. A microscope slide stainer as claimed in claim 3, wherein the platform further comprises a slide support that has plural heated surface areas.

5. A microscope slide stainer as claimed in claim 4, wherein the platform comprises plural slide supports.

6. A microscope slide stainer as claimed in claim 1, further comprising a resistive heating element underlying the heated surface area.

7. A microscope slide stainer as claimed in claim 1, further comprising a stationary liquid dispensing station, the platform being a moving platform adapted to index slides to the liquid dispensing station.

8. A method for processing biological samples mounted on microscope slides, comprising:
a. placing a microscope slide on a heated surface area of a platform, the surface area being heated by a heater thereunder and the platform being adapted to support a plurality of slides;
b. causing relative movement of a liquid dispenser and the platform with respect to each other so as to align the liquid dispenser over a microscope slide; and
c. dispensing liquid reagent from the liquid dispenser onto the slide.

9. A method as claimed in claim 8 wherein the platform comprises a plurality of heated surface areas.

10. A method as claimed in claim 8 wherein the heated surface area supports only one slide.

11. A method as claimed in claim 10 wherein a slide support on the platform has plural heated surface areas.

12. A method as claimed in claim 11 wherein plural slide supports are on the platform.

13. A method as claimed in claim 8 wherein the heated surface area is heated by an underlying resistive heating element.

14. A method as claimed in claim 8 wherein the liquid dispenser is positioned at a stationary liquid dispensing station, the platform being moved to index slides to the liquid dispensing station.
